(19) United States
(12) Patent Application Publication
(10) Pub. No.: US 2025/0165944 A1
(43) Pub. Date: May 22, 2025

(54) TRANSACTION PROCESSING SYSTEM

(71) Applicant: TOSHIBA TEC KABUSHIKI KAISHA, Tokyo (JP)

(72) Inventor: Yusuke Nagatomo, Ota Tokyo (JP)

(21) Appl. No.: 18/925,082

(22) Filed: Oct. 24, 2024

(30) Foreign Application Priority Data
Nov. 17, 2023 (JP) 2023-196064

(51) Int. Cl. G06Q 20/20

(52) U.S. Cl. CPC G06Q 20/201; G06Q 20/208

(57) ABSTRACT

A transaction processing system includes an imaging unit, a recognition unit, an approval unit, a registration unit, and a settlement unit. The imaging unit obtains an image by imaging a commodity placed in a storage place provided in a store. The recognition unit recognizes the commodity reflected in the image, using the image obtained by the imaging unit. The approval unit causes staff to confirm a recognition result by the recognition unit and the image used by the recognition unit to obtain the recognition result at a location different from the store, and receives approval by the staff for the recognition result by the recognition unit. The registration unit registers a transaction commodity based on the recognition result approved by the approval unit. The settlement unit causes a purchaser of the commodity placed in the storage place to settle a price for the transaction commodity registered by the registration unit.

### CROSS-REFERENCE TO RELATED APPLICATION

This application is based upon and claims the benefit of priority from Japanese Patent Application No. 2023-196064, filed on Nov. 17, 2024, the entire contents of which are incorporated herein by reference.

### FIELD

Embodiments described herein relate generally to a transaction processing system and a transaction processing method.

### BACKGROUND

A transaction processing device that registers a transaction commodity using technology that recognizes the commodity based on the characteristics on an image of the commodity reflected in the image has already been known.

However, due to problems with the accuracy of recognition, confirmation of recognition results by a clerk was necessary. Thus, although the trouble of clerks involved in the operation of transaction processing devices can be reduced, it did not lead to a reduction in the number of clerks.

In view of these circumstances, it has been desirable to be able to reduce the number of personnel to be placed in stores.

### DESCRIPTION OF THE DRAWINGS

FIG. 1 is a block diagram illustrating a schematic configuration of a transaction processing system according to one embodiment;

FIG. 2 is a block diagram illustrating a main circuit configuration of a store terminal;

FIG. 3 is a diagram schematically illustrating a configuration of transaction data;

FIG. 4 is a block diagram illustrating a main circuit configuration of a support management device;

FIG. 5 is a diagram schematically illustrating a configuration of a single data record included in management data;

FIG. 6 is a block diagram illustrating a main circuit configuration of a transaction support device;

FIG. 7 is a sequence diagram for a process relating to one transaction;

FIG. 8 is a diagram illustrating a first example of a user interface screen; and

FIG. 9 is a diagram illustrating a second example of the user interface screen.

### DETAILED DESCRIPTION

An aspect of the present disclosure is to provide a transaction processing system that enables the reduction of the number of personnel to be placed in stores.

In general, according to one embodiment, a transaction processing system includes an imaging means, a recognition means, an approval means, a registration means, and a settlement means. The imaging means obtains an image by imaging a commodity placed in a storage place provided in a store. The recognition means recognizes the commodity reflected in the image, using the image obtained by the imaging means. The approval means causes a staff to confirm a recognition result by the recognition means and the image used by the recognition means to obtain the recognition result at a location different from the store, and receives approval by the staff for the recognition result by the recognition means. The registration means registers a transaction commodity based on the recognition result approved by the approval means. The settlement means causes a purchaser of the commodity placed in the storage place to settle a price for the transaction commodity registered by the registration means.

Hereinafter, an exemplary embodiment will be described with reference to the drawings.

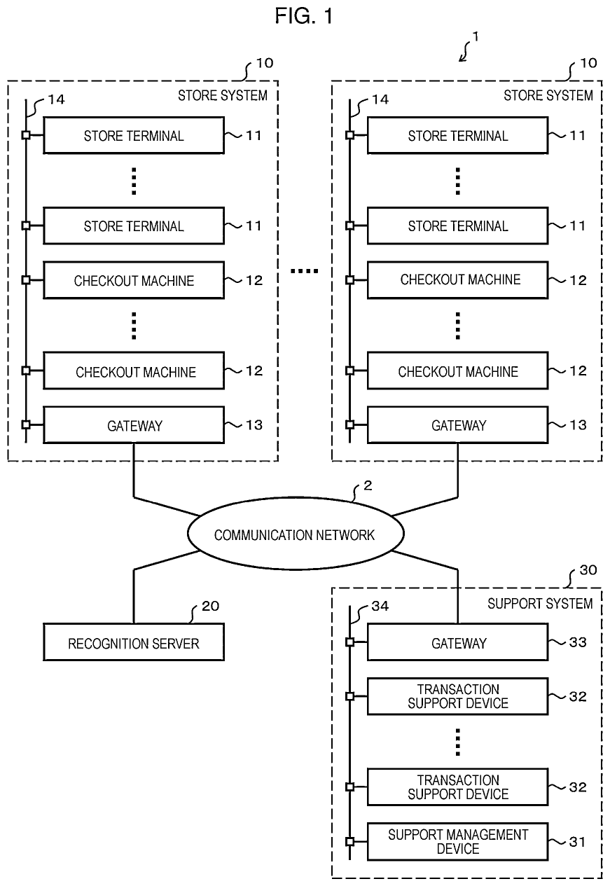

FIG. 1 is a block diagram illustrating a schematic configuration of a transaction processing system 1 according to the present embodiment.

The transaction processing system 1 is configured so that a plurality of store systems 10, a recognition server 20, and a support system 30 can be communicated via a communication network 2. As the communication network 2, the Internet, a virtual private network (VPN), a LAN, a public communication network, a mobile communication network, or the like can be used alone or in combination as appropriate. As the communication network 2, the Internet or the VPN is used as an example.

The plurality of store systems 10 are all provided at separate stores that display and sell commodities to customers who are purchasers. The plurality of stores may include a plurality of stores operated by the same business operator, or stores operated separately by different business operators. The store system 10 includes a plurality of store terminals 11, a plurality of checkout machines 12, a gateway 13, and an in-store network 14. However, only a single store terminal 11 may be included in the store system 10. Further, only a single checkout machine 12 may be included in the store system 10. The number of store terminals 11 included in each of the plurality of store systems 10 is freely and selectively determined. Further, the number of checkout machines 12 included in each of the plurality of store systems 10 is freely and selectively determined.

The store terminal 11 and the checkout machine 12 can communicate with each other via the in-store network 14. The store terminal 11 and the checkout machine 12 can also perform communication via the communication network 2 via the in-store network 14 and the gateway 13.

The store terminal 11 is an information processing device that functions as a user interface for an operator when processing transactions to sell commodity to the customers in stores. The operator of the store terminal 11 is mainly a customer. The clerk may be the operator of the store terminal 11.

The checkout machine 12 is an information processing device that performs a payment process related to settlement of the price of the above transaction. The checkout machine 12 is operated by an operator during a payment process. The operator of the checkout machine 12 is mainly a customer. The clerk may be the operator of the checkout machine 12. As the checkout machine 12, for example, a checkout machine used in an existing semi-self POS system can be used as is. In other words, the checkout machine 12 has a function as the settlement unit.

The gateway 13 relays communication in the communication network 2 and communication in the in-store network 14. As the gateway 13, for example, a well-known communication device compatible with the communication system of the communication network 2 and the communication system of the in-store network 14 may be used as is.

The in-store network 14 is a communication network provided within one store. A LAN is typically used as the in-store network 14. Another any type of communication network that enables computer communication may be used as the in-store network 14.

The recognition server 20 processes image data sent from the store terminal 11 and identifies commodities reflected in an image represented by the image data. The recognition server 20 notifies the support system 30 of the recognition result. The recognition server 20, for example, is implemented as a cloud server providing the above process as a cloud service.

The support system 30 is provided in a support center located at a location different from any of the plurality of stores where the plurality of store systems 10 are provided. The support system 30 is operated by an operator different from any of the operators of the plurality of store systems 10. In other words, the support system 30 provides support services related to transactions in the plurality of store systems 10. However, any of the operators of the plurality of store systems 10 and the operator of the support system 30 may be the same.

The support system 30 includes a support management device 31, a plurality of transaction support devices 32, a gateway 33, and an in-center network 34.

The support management device 31 and the plurality of transaction support devices 32 can communicate with each other via the in-center network 34. The support management device 31 and the transaction support device 32 can also perform communication via the communication network 2, via the in-center network 34 and the gateway 33.

The support management device 31 is an information processing device that performs a management process to make the plurality of transaction support devices 32 perform the support process to be described later.

The transaction support device 32 is an information processing device that performs the support process to be described later while receiving the operation by an operator. The operator of the transaction support device 32 is a staff stationed at the support center to support transactions at stores.

The gateway 33 relays communication in the communication network 2 and communication in the in-center network 34. As the gateway 33, for example, a well-known communication device compatible with the communication system of the communication network 2 and the communication system of the in-center network 34 can be used as is.

The in-center network 34 is a communication network provided within the support center. A LAN is typically used as the in-center network 34. Another any type of communication network that enables computer communication may be used as the in-center network 34.

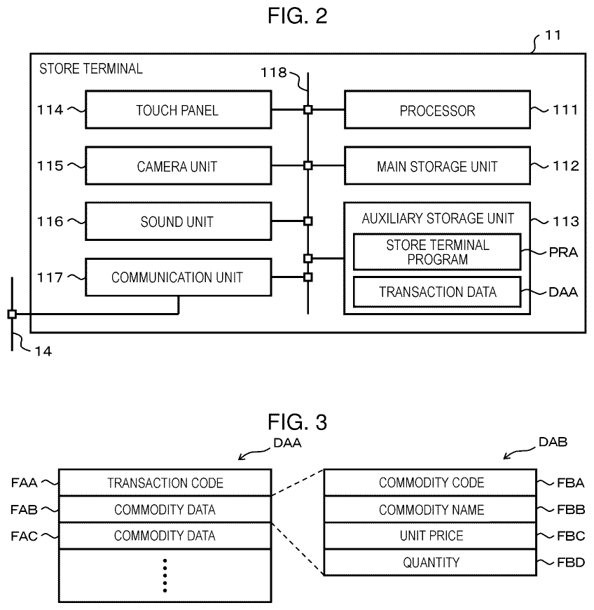

FIG. 2 is a block diagram illustrating a main circuit configuration of the store terminal 11.

The store terminal 11 includes a processor 111, a main storage unit 112, an auxiliary storage unit 113, a touch panel 114, a camera unit 115, a sound unit 116, a communication unit 117, and a transmission line 118. The processor 111, the main storage unit 112, the auxiliary storage unit 113, the touch panel 114, the camera unit 115, the sound unit 116, and the communication unit 117 are connected to each other via the transmission line 118.

A computer that performs an information process to control the store terminal 11 is configured by connecting the processor 111, the main storage unit 112, and the auxiliary storage unit 113 with the transmission line 118.

The processor 111 corresponds to the central part of the computer. The processor 111 performs the information process to implement various functions as the store terminal 11 in accordance with an information processing program such as an operating system and an application program.

The main storage unit 112 is equivalent to the main storage part of the computer described above. The main storage unit 112 includes a memory area dedicated to reading and a rewritable memory area. The main storage unit 112 stores part of the above information processing program in the memory area dedicated to reading. Further, the main storage unit 112 may read out data necessary for the processor 111 to execute a process to control each part and store the data in the memory area dedicated to reading or the rewritable memory area. The main storage unit 112 uses the rewritable memory area as a work area by the processor 111.

The auxiliary storage unit 113 is equivalent to the auxiliary storage part of the computer described above. As the auxiliary storage unit 113, for example, an electric erasable programmable read-only memory (EEPROM), a hard disc drive (HDD), a solid state drive (SSD), or various other well-known storage devices can be used. The auxiliary storage unit 113 stores data used by the processor 111 to perform various processes and data generated by the process by the processor 111. The auxiliary storage unit 113 may also store the information processing program described above. The auxiliary storage unit 113 stores a store terminal program PRA, which is one of the information processing programs in the present embodiment. A portion of the storage area of the auxiliary storage unit 113 is used as an area for storing transaction data DAA. The transaction data DAA is data representing a list of registered transaction commodities for one transaction.

The touch panel 114 displays a screen for presenting information to an operator. Further, the touch panel 114 allows an operator to input instructions by touching the screen.

The camera unit 115 obtains an image by imaging an imaging range that includes the entire predetermined storage place. Then, the camera unit 115 outputs image data representing the images obtained by imaging. Note that the camera unit 115 is equipped with a still camera, and imaging may be repeated at a fixed cycle, or imaging may be performed in response to instructions from the processor 111. Further, the camera unit 115 may be equipped with a video camera to capture moving images. The camera unit 115 may be equipped with a plurality of imaging devices. The camera unit 115 is an example of an imaging unit.

The sound unit 116 is equipped with a sound processor, an amplifier, a speaker, or the like, and reproduces various sounds such as voice, chime sound, buzzer sound, music, or the like.

The communication unit 117 performs a communication process for data communication via the in-store network 14. An existing communication device for a LAN, for example, can be used as the communication unit 117. Note that access to the in-store network 14 by the communication unit 117 may be either a wired access method or a wireless access method.

The transmission line 118 includes an address bus, a data bus, a control signal line, or the like, and transmits data and control signals sent and received between connected parts.

FIG. 3 is a diagram schematically illustrating a configuration of the transaction data DAA.

The transaction data DAA is generated for transactions processed using the store terminal 11 and stored in the auxiliary storage unit 113.

The transaction data DAA includes a field FAA, and may also include any number of fields after the field FAB. A transaction code as an identifier for the corresponding transaction is set in the field FAA. When there is a transaction commodity registered as the target of the transaction, fields FAB, FAC, correlated with each transaction commodity are added to the transaction data DAA. Commodity data DAB relating to each separate transaction commodity is set in the fields FAB, FAC, . . . .

A single piece of commodity data DAB includes fields FBA, FBB, FBC, and FBD. A commodity code as an identifier for the correlated transaction commodity is set in the field FBA. A commodity name determined for the correlated transaction commodity is set in the field FBB. The unit price of the correlated transaction commodity is set in the field FBC. The quantity of the correlated transaction commodity is set in the field FBD. Note that the commodity data may include various other types of information, such as discount information.

The store terminal 11 is generally transferred in a state where the store terminal program PRA is stored in the auxiliary storage unit 113. However, the hardware in a state where the store terminal program PRA is not stored in the auxiliary storage unit 113 or where another version of an application program of the same type is stored in the auxiliary storage unit 113, and the store terminal program PRA may be separately transferred. Further, the store terminal 11 may be configured by writing the store terminal program PRA into the auxiliary storage unit 113 in response to the operation by any operator. The store terminal program PRA can be transferred by being recorded on a removable recording medium such as a magnetic disk, a magneto-optical disk, an optical disk, a semiconductor memory, or the like, or through communication via a network.

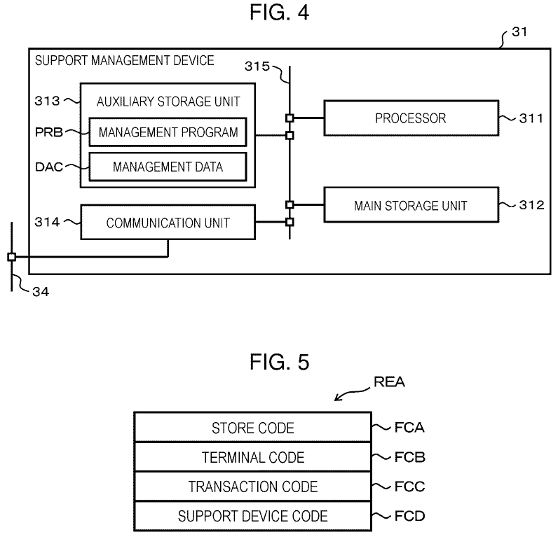

FIG. 4 is a block diagram illustrating a main circuit configuration of the support management device 31.

The support management device 31 includes a processor 311, a main storage unit 312, an auxiliary storage unit 313, a communication unit 314, and a transmission line 315.

Since the functions of the processor 311, the main storage unit 312, the auxiliary storage unit 313, and the transmission line 315 are roughly the same as those of the processor 111, the main storage unit 112, the auxiliary storage unit 113, and the transmission line 118, a description thereof will be omitted. However, the auxiliary storage unit 313 stores a management program PRB instead of the store terminal program PRA. The management program PRB is an application program describing the procedure for a management process to be described later. Further, a part of the storage area of the auxiliary storage unit 313 is used to store management data DAC instead of storing the transaction data DAA. The management data DAC is data for managing the allocation status of the support process to the transaction support device 32.

The communication unit 314 performs a communication process for data communication via the in-center network 34. An existing communication device for a LAN, for example, can be used as the communication unit 314. Note that access to the in-center network 34 by the communication unit 314 may be either a wired access method or a wireless access method.

FIG. 5 is a diagram schematically illustrating a configuration of a single data record REA included in the management data DAC.

The management data DAC is a set of data record REA correlated with each transaction being supported by the transaction support device 32. Therefore, the number of data records REAs included in the management data DAC changes according to the number of transactions being supported. In a situation where support is not provided by any of the transaction support devices 32, the management data DAC does not include a single data record REA, or the management data DAC is not stored in the auxiliary storage unit 313.

The data record REA includes fields FCA, FCB, FCC, and FCD. A store code as an identifier for the store where the correlated transaction is being performed is set in the field FCA. Further, the store code is predetermined such that all stores included in the transaction processing system 1 can be identified. A terminal code which is an identifier of the store terminal 11 used for correlated transactions is set in the field FCB. Furthermore, the terminal code is predetermined such that at least a plurality of store terminals 11 installed in the same store can be identified. A transaction code as an identifier for the correlated transaction is set in the field FCC. A support device code as an identifier for the transaction support device 32 used to support the correlated transaction is set in the field FCD. Note, the support device code is predetermined such that each transaction support device 32 can be identified.

It is assumed that hardware of a general-purpose information processing device for servers, for example, is used as basic hardware for the support management device 31. Further, the support management device 31 is generally transferred in a state where the management program PRB is stored in the auxiliary storage unit 313. However, hardware in a state where the management program PRB is not stored in the auxiliary storage unit 313, or where another version of an application program of the same type is stored in the auxiliary storage unit 313, and the management program PRB may be individually transferred. Further, the support management device 31 may be configured by writing the management program PRB into the auxiliary storage unit 313 in response to the operation by any operator. The management program PRB can be transferred by being recorded on a removable recording medium such as a magnetic disk, a magneto-optical disk, an optical disk, a semiconductor memory, or the like, or through communication via a network.

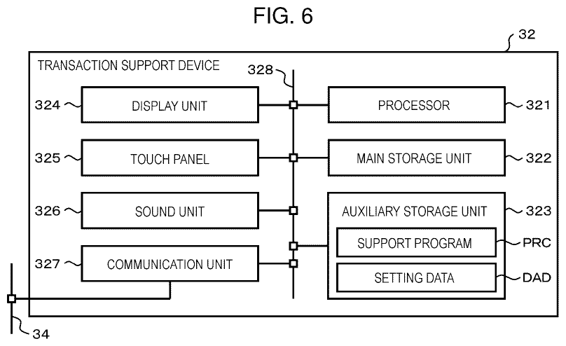

FIG. 6 is a block diagram illustrating a main circuit configuration of the transaction support device 32.

The transaction support device 32 includes a processor 321, a main storage unit 322, an auxiliary storage unit 323, a touch panel 325, a sound unit 326, a communication unit 327, and a transmission line 328.

Since the functions of the processor 321, the main storage unit 322, the auxiliary storage unit 323, the touch panel 325, the sound unit 326, and the transmission line 328 are roughly the same as those of the processor 111, the main storage unit 112, the auxiliary storage unit 113, the touch panel 114, the sound unit 116, and the transmission line 118, and the function of the communication unit 327 is roughly the same as that of the communication unit 314, a description thereof will be omitted. However, the auxiliary storage unit 323 stores the support program PRC instead of the store terminal program PRA. The support program PRC is an application program describing the procedure for a support process to be described later. Further, a part of the storage area of the auxiliary storage unit 323 is used to store setting data DAD instead of storing the transaction data DAA. The setting data DAD is data representing settings for each store. The settings represented by the setting data DAD include settings relating to a user interface screen.

The display unit 324 displays various screens for presenting information to the operator. A well-known device such as a liquid crystal display device can be used as the display unit 324.

It is assumed that hardware of a general-purpose information processing device for servers, for example, is used as basic hardware for the transaction support device 32. Further, the transaction support device 32 is generally transferred in a state where the support program PRC is stored in the auxiliary storage unit 323. However, the hardware in a state where the support program PRC is not stored in the auxiliary storage unit 323 or where another version of an application program of the same type is stored in the auxiliary storage unit 323, and the support program PRC may be separately transferred. Further, the transaction support device 32 may be configured by writing the support program PRC into the auxiliary storage unit 323 in response to the operation by any operator. The support program PRC can be transferred by being recorded on a removable recording medium such as a magnetic disk, a magneto-optical disk, an optical disk, a semiconductor memory, or the like, or through communication via a network.

The operation of the transaction processing system 1 configured as described above will be described below. It should be noted that the contents of the processes described below are merely an example, and the order of some of the processes may be changed, some of the processes may be omitted, or other processes may be added, as appropriate. For example, in the following description, in order to easily explain the characteristic operations of this embodiment, the description of some processes is omitted. For example, when an error occurs, a process may be performed to deal with the error, but the description of such a process is omitted.

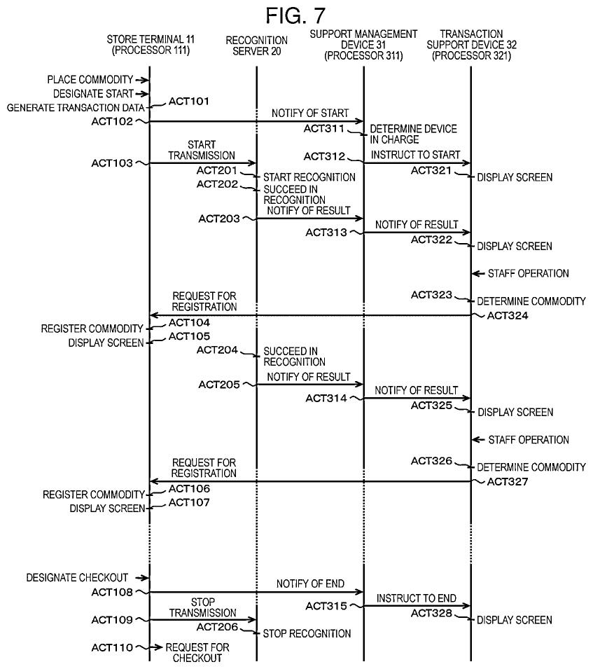

FIG. 7 is a sequence diagram for a process relating to one transaction.

A customer picks up one or a plurality of commodities to be purchased from the store's sales floor. Then, the customer selects an unused store terminal 11 out of the store terminals 11 provided at the same store, and places the commodity in a storage place provided for the store terminal 11. After that, the customer designates the store terminal 11 to start the transaction, for example, by performing a predetermined operation on the touch panel 114.

The processor 111 in the store terminal 11 designated to start in this manner starts a transaction process for one transaction in the information process based on the store terminal program PRA. In the following description of the operation, when the term “store terminal 11” is used, this refers to the store terminal 11 where the transaction process has been started.

The processor 111 generates transaction data DAA as ACT 101. In other words, the processor 111 determines, for example, a new transaction code different from a transaction code for identifying other transactions according to predetermined rules, generates new transaction data DAA containing the transaction code and not including commodity information relating to the transaction commodity, and stores the transaction data DAA in the auxiliary storage unit 113.

As ACT 102, the processor 111 notifies the support management device 31 of the start of transaction. For example, the processor 111 generates notification data in a predetermined form including a store code, a terminal code, and the transaction code determined in ACT 101, and transmits this notification data to the support management device 31 from the communication unit 117 over the in-store network 14. For each store terminal 11, for example, the store code of the store in which the store terminal 11 is installed and the terminal code determined for the store terminal 11 are stored in advance in the auxiliary storage unit 113. The processor 111 then includes the store code and terminal code stored in the auxiliary storage unit 113 in the notification data described above.

The notification data is transmitted to the support management device 31 by the in-store network 14, the gateway 13, the communication network 2, the gateway 33, and the in-center network 34. Then, the notification data transmitted in this manner is received by the communication unit 314.

In the support management device 31, the processor 311 waits for the start of a transaction to be supported during the management process based on the management program PRB. Then, when the notification data is received by the communication unit 314 as described above, the processor 311 proceeds to ACT 311.

As ACT 311, the processor 311 determines a transaction support device 32 responsible for supporting the transaction for which start has been notified. For example, the processor 311 selects one transaction support device 32 according to predetermined rules from among transaction support devices 32 that do not execute the support process to be described later, and determines the transaction support device 32 as the device in charge. The processor 311 then adds a new data record REA to the management data DAC. The processor 311 sets the store code, terminal code, and transaction code included in the notification data to the data record REA to be added here into the fields FCA, FCB, and FCC, respectively, and sets the support device code of the transaction support device 32 determined as the device in charge above into the field FCD. In the following description of the operation, when the term “transaction support device 32” is used, it refers to the transaction support device 32 that is determined to be in charge here.

The above rules may be appropriately determined, for example, by the developer of the management program PRB. As an example, the rules are determined to level the load on the transaction support device 32. As an example, the rules are determined to select a transaction support device 32 regardless of the store where the transaction is performed. As an example, the rules are determined to select a transaction support device 32 correlated with the store where a transaction is performed in advance. Rules may be determined by combining the above examples and other rules. However, it is preferable that rules are determined such that one transaction support device 32 can be in charge of transactions at plurality of stores.

As ACT 312, the processor 311 instructs the transaction support device 32 to start a support process. For example, the processor 311 generates instruction data in a predetermined form including the store code, terminal code, and transaction code included in the notification data, and transmits this instruction data from the communication unit 314 to the transaction support device 32 over the in-center network 34.

The instruction data is transmitted to the transaction support device 32 via the in-center network 34. The instruction data transmitted in this manner is then received by the communication unit 327 of the transaction support device 32.

The processor 321 of the transaction support device 32 waits for an instruction to start support during the support process based on the support program PRC. Then, when instruction data is received by the communication unit 327 as described above, the processor 321 proceeds to ACT 321.

As ACT 321, the processor 321 displays on the touch panel 325 a user interface screen for receiving operations by staff to support transactions. The processor 321 determines, based on the setting data DAD, the user interface screen to be displayed, so as to be suitable for the store in which the store terminal 11 is installed. In other words, the processor 321 makes the user interface screen to be displayed different according to the store where the transaction is being performed. Details of the interface screen will be described later. Thus, since the processor 321 performs an information process based on the support program PRC, a computer with the processor 321 as a central part functions as the display unit.

When the processor 111 in the store terminal 11 makes a notification of the start in ACT 102, the process proceeds to ACT 103.

As ACT 103, the processor 111 starts transmitting the image data obtained by the camera unit 115 to the recognition server 20. When the camera unit 115 is equipped with a still camera, and repeats imaging at a fixed cycle, the processor 111 sequentially transmits all or part of image data output from the camera unit 115 at a fixed cycle. When the camera unit 115 is equipped with a still camera, and performs imaging in response to instructions from the processor 111, the processor 111 instructs imaging at a predetermined fixed cycle, and sequentially transmits the image data output from the camera unit 115 in response to this. Further, when the camera unit 115 is equipped with a video camera to capture a video, the processor 111 transmits the image data output from the camera unit 115, that is, video data. Note, for example, when transmitting image data, the processor 111 compresses and encodes the image data output by the camera unit 115 using a predetermined coding system, and then transmits transfer data in a predetermined form containing this encoded image data and the terminal code of the transmission source store terminal 11 to the recognition server 20 from the communication unit 117 over the in-store network 14.

The transfer data is transmitted to the recognition server 20 via the in-store network 14, the gateway 13, and the communication network 2.

When receiving the transfer data described above, the recognition server 20 proceeds to ACT 201.

The recognition server 20 starts a process (hereinafter referred to as a recognition process) for recognizing a commodity as ACT 201. In the recognition process, the recognition server 20 recognizes a commodity reflected in an image represented by the image data included in the transfer data, based on the characteristics of the commodity shown in the image. As the recognition process, for example, a well-known process using an image recognition engine that has been machine-learned can be applied. In other words, the recognition server 20 has a function as a recognition unit.

When the commodity is not reflected in the image, or depending on the state of reflection of the commodity, the recognition server 20 may not recognize the commodity. Then, when the recognition server 20 succeeds in recognition as ACT 202, the process proceeds to ACT 203.

As ACT 203, the recognition server 20 notifies the support management device 31 of the recognition result. For example, the recognition server 20 transmits notification data in a predetermined form including a commodity code as an identifier for the recognized commodity, image data taken into consideration when the commodity was successfully identified, and a terminal code included in the transfer data together with the image data to the support management device 31 over the communication network 2.

The notification data is transmitted to the support management device 31 via the communication network 2, the gateway 33, and the in-center network 34. Then, the notification data transmitted in this manner is received by a communication unit 314 of the support management device 31.

When the notification data for notification of recognition result is received by the communication unit 314 as described above, the processor 311 proceeds to ACT 313.

As ACT 313, the processor 311 transfers the notification data received as described above to the transaction support device 32. In other words, the processor 311 determines a transaction support device 32 that is in charge of support relating to transactions using a store terminal 11 identified by the terminal code included in the notification data, and sends notification data from the communication unit 314 to the transaction support device 32 over the in-center network 34. More specifically, the processor 311 searches the management data DAC for a data record REA in which the terminal code included in the notification data is set in the field FCB. Then, for example, the processor 311 uses, as a transfer destination, a transaction support device 32 identified by a support device code set in the field FCD of the data record REA.

When the notification data is received by the communication unit 327 in the transaction support device 32, the processor 321 proceeds to ACT 322.

As ACT 322, the processor 321 displays a confirmation screen for staff to confirm the recognition result on the display unit 324. The confirmation screen is, for example, a screen that displays the commodity name of the recognized commodity and an image based on the image data.

The staff checks the confirmation screen and checks whether the recognition result is appropriate. Then, when it is determined that the recognition result is appropriate, the staff performs a predetermined operation to approve the recognition result, for example, on the touch panel 325. Further, when the staff determines that the recognition result is not appropriate, the staff determines the commodity based on the image displayed on the confirmation screen, and performs predetermined operations for designating the commodity, for example, on the touch panel 325.

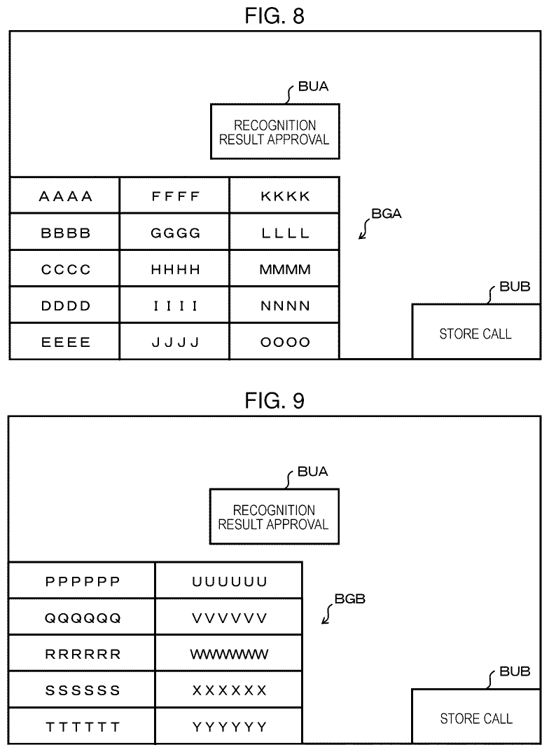

FIG. 8 is a diagram illustrating a first example of the user interface screen.

FIG. 9 is a diagram illustrating a second example of the user interface screen.

In FIG. 8 and FIG. 9, only some of the display objects are shown, and some of the display objects are omitted.

The user interface screens shown in FIG. 8 and FIG. 9 include buttons BUA and BUB in common. The button BUA is a soft key for receiving approval from staff regarding recognition results. The button BUB is a soft key for receiving designation by a staff by calling a store clerk. Further, the user interface screen shown in FIG. 8 further includes a keypad BGA. The user interface screen shown in FIG. 9 further includes a keypad BGB. The keypad BGA includes 15 preset buttons for designating commodities. In contrast to this, the keypad BGB includes 10 preset buttons for designating commodities, and the size of each preset button is larger than the keypad BGA. Further, commodities preset in each preset button are also different from each other in the keypad BGA and the keypad BGB. The character string such as “AAAA” or “PPPPPP” displayed above each preset button is actually a character string representing a commodity name, or the like.

Compared to the user interface screen shown in FIG. 9, the user interface screen shown in FIG. 8 is suitable for stores having a large amount of commodities where there is a high possibility that staff will perform operations to designate these commodities because there is a high possibility that recognition by the recognition server 20 will fail.

When approving the recognition results shown on the confirmation screen, the staff taps, for example, a button BUA. When the staff does not approve the recognition result shown on the confirmation screen, a commodity is designated by, for example, tapping any of the preset keys included in the user interface screen.

When such an operation is performed by the staff, the processor 321 proceeds to ACT 323.

As ACT 323, the processor 321 determines a commodity to be registered in response to the operation by the staff. In other words, when the staff approves the recognition result, the processor 321 determines the commodity recognized by the recognition server 20 as the commodity to be registered, for example. Further, for example, when the staff designates a commodity, the processor 321 determines the designated commodity as the commodity to be registered. Thus, when the processor 321 performs an information process based on the support program PRC, a computer with the processor 321 as a central part functions as the approval unit and the designation unit.

As ACT 324, the processor 321 requests the store terminal 11 to register the commodities determined above. For example, the processor 321 transmits request data in a predetermined form containing the commodity code of the commodity determined above from the communication unit 327 over the in-center network 34 to the store terminal 11 identified by the terminal code included in the notification data for result notification. Thus, when the processor 321 performs an information process based on the support program PRC, a computer with the processor 321 as a central part functions as the notification unit.

This request data is transmitted to the destination store terminal 11 via the in-center network 34, the gateway 33, the communication network 2, the gateway 13, and the in-store network 14. The request data is then received by the communication unit 117 of the destination store terminal 11.

The processor 111 in the store terminal 11 where the request data has been received as described above proceeds to ACT 104.

As ACT 104, the processor 111 registers the commodity as a transaction commodity in response to a request. For example, the processor 111 adds new commodity data relating to commodities identified by commodity codes included in the request data to the transaction data DAA. Thus, since the processor 111 performs an information process based on the store terminal program PRA, a computer with the processor 111 as a central part functions as the registration unit.

As ACT 105, the processor 111 displays a guide screen on the touch panel 114 for guiding customers to remove commodities registered as transaction commodities from the storage place as described above.

The customer follows the guidance on the guide screen, removes the registered commodities among the commodities placed in the storage place from the storage place and packs the registered commodities in a bag.

As ACT 204, ACT 205, ACT 314, ACT 325, ACT 326, ACT 327, ACT 106, and ACT 107, when another commodity is placed in the storage place, the other commodity is registered as the transaction commodity in the same manner as in ACT 202, ACT 203, ACT 313, ACT 322, ACT 323, ACT 324, ACT 104, and ACT 105. When another commodity is placed in the storage place, the same process is repeated.

When all commodities placed in the storage place are removed from the storage place, the customer designates payment by a predetermined operation on the touch panel 114, for example. When such an operation is performed, the processor 111 proceeds to ACT 108.

As ACT 108, the processor 111 notifies the support management device 31 of transaction completion. For example, the processor 111 generates notification data in a predetermined form including a store code, a terminal code, and the transaction code determined in ACT 101, and transmits this notification data to the support management device 31 from the communication unit 117 over the in-store network 14.

The notification data is transmitted to the support management device 31 by the in-store network 14, the gateway 13, the communication network 2, the gateway 33, and the in-center network 34. Then, the notification data transmitted in this manner is received by a communication unit 314.

When the above notification data is received, the processor 311 proceeds to ACT 315.

As ACT 315, the processor 311 instructs the transaction support device 32, which performs support relating to transactions for which notification of completion has been given, to complete the support process. For example, the processor 311 searches the management data DAC for a data record REA in which the store code, terminal code, and transaction code included in the notification data are set in the fields FCA, FCB, and FCC, respectively. Then, for example, the processor 311 sends instruction data in a predetermined form for completion instructions to the transaction support device 32 identified by the support device code set in the field FCD of the corresponding management data DAC from the communication unit 314 over the in-center network 34.

The instruction data is transmitted to the transaction support device 32 via the in-center network 34. The instruction data transmitted in this manner is then received by the communication unit 327 of the destination transaction support device 32. The processor 321 then proceeds to ACT 328 in response to this.

As ACT 328, the processor 321 displays, on the display unit 324, a predetermined notification screen for notifying staff of transaction completion.

Further, as ACT 109, the processor 111 in the store terminal 11 stops transmitting image data. Then, when the image data cannot be received due to this, the recognition server 20 stops recognition as ACT 206.

As ACT 110, the processor 111 requests the checkout machine 12 to settle the prices relating to all registered transaction commodities at the store terminal 11. In other words, the processor 111 generates, for example, request data in a predetermined form including the transaction data DAA. Then, for example, the processor 111 transmits the request data to the pre-correlated checkout machine 12, among a plurality of checkout machines 12. The processor 111 may, for example, calculate the amount to be settled and then request the checkout machine 12 to settle that amount. Alternatively, the processor 111 may request payment from the checkout machine 12 in response to a request from the checkout machine 12 selected by the customer. The checkout machine 12 performs a settlement process for the customer to settle the price.

As described above, the transaction processing system 1 makes staff stationed at the support center to confirm commodity recognition results from images, by displaying the results on the transaction support device 32 installed in the support center different from the store where the transaction is performed. Thus, there is no need for personnel involved in confirming commodity recognition results from images to be placed in each store terminal 11, and it is possible to reduce the number of personnel to be placed in the store.

Furthermore, the transaction processing system 1 can allocate a support process related to transactions performed using a plurality of store terminals 11 installed in one store and a plurality of store terminals 11 each installed at a plurality of stores to one transaction support device 32. Thus, one staff can be in charge of a plurality of store terminals 11, efficient support is possible, and the number of personnel required for the entire system can also be reduced.

Furthermore, in the transaction support device 32, the user interface screen is changed according to the store where the transaction to be processed in the support process is performed. Thus, staff can easily perform operations adapted to the circumstances of each store.

This embodiment can be modified in various ways as follows.

A camera unit or the like attached externally to the store terminal 11 may be used as the imaging unit. Alternatively, a network camera or the like that is directly connected to the in-store network 14 or the communication network 2 and transmits image data to the recognition server 20 without going through the store terminal 11 may be used as the imaging unit.

The recognition process may be executed by any one of the processors 111, 311, 321, or by a processor provided in any other information processing device. In other words, the function as the recognition unit may be provided in any information processing device other than the recognition server 20.

The process for registering transaction commodities may be executed by either processor 311 or 321, or by a processor included in any other information processing device. In other words, the function as the registration unit may be provided in any information processing device other than the store terminal 11.

The store terminal 11 may be equipped with the function of the checkout machine 12.

Each function implemented by the processors 111, 311, and 321 through an information process can also be implemented in part or in whole by hardware that performs the information process that is not based on a program, such as a logic circuit. Further, each of the above functions can also be implemented by combining software control with hardware such as the logic circuit described above.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transaction processing system, comprising:
an imaging component for obtaining an image by imaging a commodity in a storage place provided in a store;
a recognition component for recognizing the commodity reflected in the image based upon the image obtained by the imaging component;
an approval component for causing a staff to confirm a recognition result by the recognition component and the image used by the recognition component to obtain the recognition result at a location different from the store, and receiving approval by the staff for the recognition result by the recognition component;
a registration component for registering a transaction commodity based on the recognition result approved by the approval component; and
a settlement component for causing a purchaser of the commodity in the storage place to settle a price for the transaction commodity registered by the registration component.

2. The transaction processing system according to claim 1, further comprising:
a designation component for receiving a designation by the staff for a commodity different from the recognition result by the recognition component, wherein
the registration component registers the transaction commodity based on the recognition result approved by the approval component, and registers the commodity designated by the designation component as the transaction commodity.

3. The transaction processing system according to claim 1, further comprising:
a plurality of store terminals each of which includes the imaging component and the registration component and which is associated with a plurality of storage places; and
a transaction support device equipped with the approval component, wherein
the transaction support device further includes a notification component for notifying the store terminal that approval is made by the approval component, the store terminal including the imaging component that captures the image used by the recognition component to obtain the recognition result subject to the approval, and
the registration component registers the transaction commodity based on the recognition result for which notification of approval by the notification component is received.

4. The transaction processing system according to claim 3, wherein
at least some store terminals among the plurality of store terminals are associated with the plurality of storage places defined in the plurality of stores, respectively.

5. The transaction processing system according to claim 1, wherein
a plurality of store terminals equipped with the imaging component and respectively connected to the storage places defined in the plurality of stores; and
a transaction support device equipped with the approval component, wherein
the transaction support device includes
a designation component for receiving designation by the staff for a commodity different from a recognition result by the recognition component, and
a display for displaying a different user interface screen in order to receive designation by the designation component, depending on which of the plurality of stores the transaction is supported, and
the registration component registers the transaction commodity based on the recognition result approved by the approval component, and registers the commodity designated by the designation component as the transaction commodity.

6. The transaction processing system according to claim 1, wherein the settlement component is a semi-self POS apparatus.

7. The transaction processing system according to claim 1, wherein the imaging component is camera configured to capture at least one of a still image and a moving image.

8. The transaction processing system according to claim 1, further comprising:
a notification component that notifies a store server of a start of a transaction.

9. The transaction processing system according to claim 8, wherein the notification component generates notification data in a predetermined form including at least one of a store code, a terminal code, and a transaction code.

10. The transaction processing system according to claim 1, wherein the recognition component transmits commodity notification data in a predetermined form including a commodity code as an identifier for the transaction commodity.

11. A transaction processing method, comprising:
obtaining an image by imaging a commodity in a storage place provided in a store;
recognizing, using a recognition component, the commodity reflected in the image based upon the image obtained;
causing a staff to confirm a recognition result by the recognition component and the image used by the recognition component to obtain the recognition result at a location different from the store, and receiving approval by the staff for the recognition result;
registering, using a registration component, a transaction commodity based on the recognition result approved; and
causing a purchaser of the commodity in the storage place to settle a price for the transaction commodity registered by the registration component.

12. The transaction processing method according to claim 11, further comprising:
receiving, by a designation component, a designation by the staff for a commodity different from the recognition result by the recognition component; and
registering the transaction commodity based on the recognition result approved, and registering the commodity designated by the designation component as the transaction commodity.

13. The transaction processing method according to claim 11, wherein
a plurality of store terminals each of which includes the imaging component and the registration component and which is associated with a plurality of storage places, and a transaction support device, further comprising:
notifying, by the transaction support device, the store terminal that approval is made, the store terminal including the imaging component that captures the image used by the recognition component to obtain the recognition result subject to the approval; and
registering the transaction commodity based on the recognition result for which notification of approval is received.

14. The transaction processing method according to claim 13, wherein
at least some store terminals among the plurality of store terminals are associated with the plurality of storage places defined in the plurality of stores, respectively.

15. The transaction processing method according to claim 11, wherein
a plurality of store terminals equipped with the imaging component and respectively connected to the storage places defined in the plurality of stores, and a transaction support device, further comprising:
receiving designation by the staff for a commodity different from a recognition result by the recognition component;
displaying a different user interface screen in order to receive designation by the designation component, depending on which of the plurality of stores the transaction is supported; and
registering the transaction commodity based on the recognition result approved, and registering the commodity designated by the designation component as the transaction commodity.

16. The transaction processing method according to claim 11, wherein the settlement component is a semi-self POS apparatus.

17. The transaction processing method according to claim 11, further comprising:
capturing at least one of a still image and a moving image.

18. The transaction processing method according to claim 11, further comprising:
notifying a store server of a start of a transaction.

19. The transaction processing method according to claim 18, further comprising:
generating notification data in a predetermined form including at least one of a store code, a terminal code, and a transaction code.

20. The transaction processing method according to claim 11, further comprising:
transmitting commodity notification data in a predetermined form including a commodity code as an identifier for the transaction commodity.
